(19) United States
(12) Patent Application Publication
(10) Pub. No.: US 2006/0246935 A1
(43) Pub. Date: Nov. 2, 2006

(54) Scheduling apparatus and scheduling apparatus method

(75) Inventors: Hitoshi Iochi, Kanagawa (JP); Hidetoshi Suzuki, Kanagawa (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 10/549,313

(22) PCT Filed: Jan. 25, 2005
(86) PCT No.: PCT/JP05/00927

§ 371 Date: Sep. 16, 2005

(30) Foreign Application Priority Data
Feb. 13, 2004 (JP) 2004037082

(51) Int. Cl. H04B 7/00

(52) U.S. Cl. 455/522

(57) ABSTRACT

A scheduling apparatus is provided that enables user throughput and system throughput to be improved in a radio communication system. In this apparatus, a management section (100) distributes a reception power resource set by a radio network controller (10) to a plurality of transmission schemes used in uplink data transmission based on information reported from mobile station apparatuses (30-1 through 30-N). A first transmission scheme scheduling section (110) and second transmission scheme scheduling section (120) execute uplink data transmission scheduling in accordance with reception power resources distributed to the plurality of transmission schemes.

### TECHNICAL FIELD

The present invention relates to a scheduling apparatus and scheduling method, and more particularly to a scheduling apparatus and scheduling method for uplink data transmission in a radio communication system.

### BACKGROUND ART

With the introduction of HSDPA (High Speed Downlink Packet Access), higher downlink speeds are being achieved in WCDMA (Wideband Code Division Multiple Access) systems. Along with this, various kinds of techniques for increasing speed and reducing delays in uplinks, known as Uplink Enhancement, are being studied.

The general configuration of a WCDMA radio communication system includes a Radio Network Controller (RNC), Base Stations (BSs), and Mobile Stations (MSs), as shown in FIG. 1. In this kind of radio communication system, management of reception power resource and so forth in uplinks is generally performed by the RNC, which is the superordinate apparatus of the BSs.

In order to have uplink data transmission operate in a stable manner in such a system, it is necessary to distribute a reception power resource to the MSs so that reception power in a base station is kept within a range up to a predetermined target value, taking account of thermal noise and interference with other cells, as shown in FIG. 2, for example. Namely, it is necessary to assign a transmission rate (or transmission rate upper limit) to each MS. This can be achieved by performing scheduling for uplink data transmission in an appropriate manner.

Performing scheduling at high speed is important in achieving increased speed and reduced delays in uplinks by means of uplink enhancement. For this reason, various scheduling related transmission schemes (transmission schemes) have been studied. Examples of transmission schemes that have been studied include Time and Rate Scheduling, Rate Scheduling, and Autonomous Transmission. FIG. 3A shows uplink data transmission based on Time and Rate Scheduling, FIG. 3B shows uplink data transmission based on Rate Scheduling, and FIG. 3C shows uplink data transmission based on Autonomous Transmission.

With Time and Rate Scheduling, transmission by an MS to which a resource is allocated is permitted by distributing comparatively large reception power resources to a comparatively small number of MSs (in FIG. 3A, MS-A). An MS for which transmission is permitted performs uplink data transmission within a transmission rate range decided at the time of scheduling and at transmission timing decided as necessary at the time of scheduling. Therefore, of the three above-mentioned transmission schemes, Time and Rate Scheduling is suitable for high-speed data transmission.

With Rate Scheduling, comparatively small reception power resources are distributed to a comparatively large number of MSs (in FIG. 3B, MS-A, MS-B, and MS-C), and thus reception power fluctuations in a BS are reduced. In this case, both a transmission rate request from an MS and transmission rate permission from a BS are implemented using approximately 1- to 2-bit signals indicating UP, DOWN, and KEEP, for example. That is to say, reception power resource distribution to an MS is changed gradually. Therefore, of the three above-mentioned transmission schemes, Rate Scheduling is suitable for medium/low-speed data transmission.

With Autonomous Transmission, as long as a predetermined transmission rate is not exceeded, MSs (in FIG. 3C, MS-A, MS-B, and MS-C) can perform transmission without BS permission. A low transmission rate is generally used with this scheme. Therefore, of the three above-mentioned transmission schemes, Rate Scheduling is suitable for low-delay data transmission at a low transmission rate.

In uplink enhancement, investigation has also been carried out into uplink data transmission based on a combination of a plurality of transmission schemes mainly including the three above-described transmission schemes. For example, in Non-patent Document 1, uplink data transmission based on a combination of Time and Rate Scheduling and Autonomous Transmission is proposed, and in Non-patent Document 2, a combination of Time and Rate Scheduling (referred to in this document as “Time Scheduling”) and Rate Scheduling is expressly stated to be possible, although a detailed description of this combination is not given.

Non-patent Document 1: “Reference Node-B scheduler for EUL”, Qualcomm Europe, 3rd Generation Partnership Projects, R1-031246, November 2003

Non-patent Document 2: “Text Proposal: Node B Controlled Scheduling”, Ericsson, 3rd Generation Partnership Projects, R1-031120, October 2003

### DISCLOSURE OF INVENTION

Problems to be Solved by the Invention

However, there have not been many proposals concerning how to distribute the reception power resource to each transmission scheme when data transmission is performed based on a combination of a plurality of transmission schemes in conventional uplink data transmission. While it is extremely important in uplink enhancement to make reception power resource distribution efficient in line with high-speed scheduling, there are nevertheless certain limitations on making reception power resource usage more efficient since there has not been much discussion of reception power resource distribution. There are consequently certain limitations on improvements to MS throughput and overall system throughput in a radio communication system.

Taking the above-described points into consideration, it is an object of the present invention to provide a scheduling apparatus and scheduling method that enable user throughput and system throughput to be improved in a radio communication system.

Means for Solving the Problem

A scheduling apparatus of the present invention employs a configuration that includes a distribution section that distributes a reception power resource set by a superordinate apparatus to a plurality of transmission schemes used in uplink data transmission, and a scheduling section that executes uplink data transmission scheduling in accordance with the reception power resources distributed to the aforementioned plurality of transmission schemes.

A base station apparatus of the present invention employs a configuration that includes a decision section that decides on a transmission scheme to be used by a mobile station apparatus based on information reported from the mobile station apparatus; a distribution section that distributes a reception power resource set by a superordinate apparatus to a plurality of transmission schemes used in uplink data transmission based on the reported information and a decision result of the decision section; a scheduling section that executes uplink data transmission scheduling in accordance with the reception power resources distributed to the plurality of transmission schemes; and a signaling section that signals a decision result of the decision section to the mobile station apparatus.

A mobile station apparatus of the present invention performs uplink data transmission to a base station apparatus, and employs a configuration that includes a reporting section that reports information relating to that mobile station apparatus to the base station apparatus; a detection section that detects signaling from the base station apparatus of a transmission scheme decision result based on reported information; and a transmitting section that performs uplink data transmission using the detected transmission scheme.

A scheduling method of the present invention has a distribution step of distributing a reception power resource set by a superordinate apparatus to a plurality of transmission schemes used in uplink data transmission, and a scheduling step of executing uplink data transmission scheduling in accordance with the reception power resources distributed to the plurality of transmission schemes.

Advantageous Effect of the Invention

The present invention enables user throughput and system throughput to be improved in a radio communication system, and also enables the amount of signaling between a superordinate apparatus and base station apparatus to be greatly reduced.

### BRIEF DESCRIPTION OF DRAWINGS

FIG. 1 is a block diagram showing the general configuration of a radio communication system;

FIG. 2 is a drawing for explaining an example of reception power resource distribution;

FIG. 3A is a drawing for explaining an example of a transmission scheme;

FIG. 3B is a drawing for explaining another example of a transmission scheme;

FIG. 3C is a drawing for explaining yet another example of a transmission scheme;

FIG. 4 is a block diagram showing the configuration of a radio communication system that has a base station apparatus according to Embodiment 1 of the present invention;

FIG. 5 is a flowchart for explaining the operation of the scheduling section in a base station apparatus according to Embodiment 1 of the present invention;

FIG. 6 is a drawing showing schematically the process of distributing reception power resources in Embodiment 1;

FIG. 7 is a chart showing mobile station apparatus variations over time;

FIG. 8 is a chart showing variations in reception power resource allocation to mobile station apparatuses in Embodiment 1;

FIG. 9 is a block diagram showing the configuration of a radio communication system that has a base station apparatus according to Embodiment 2 of the present invention;

FIG. 10 is a flowchart for explaining the operation of the scheduling section in a base station apparatus according to Embodiment 2 of the present invention;

FIG. 11 is a drawing showing schematically the process of distributing reception power resources in Embodiment 2;

FIG. 12A is a chart showing variations in reception power resource allocation to mobile station apparatuses in Embodiment 2;

FIG. 12B is a chart showing variations in the amount of data in mobile station apparatuses in Embodiment 2;

FIG. 13 is a block diagram showing the configuration of a radio communication system that has a base station apparatus according to Embodiment 3 of the present invention;

FIG. 14A is a chart showing variations in reception power resource allocation to mobile station apparatuses in Embodiment 3;

FIG. 14B is a chart showing variations in the amount of data in mobile station apparatuses in Embodiment 3;

FIG. 15 is a block diagram showing the configuration of a radio communication system that has a base station apparatus according to Embodiment 4 of the present invention;

FIG. 16A is a chart showing transmission scheme switching according to the amount of data in mobile station apparatuses in Embodiment 4;

FIG. 16B is a chart showing variations in the amount of data in mobile station apparatuses in Embodiment 4;

FIG. 17A is a chart showing transmission scheme switching according to transmission power resources in mobile station apparatuses in Embodiment 4;

FIG. 17B is a chart showing variations in transmission power resources in mobile station apparatuses in Embodiment 4;

FIG. 18 is a block diagram showing the configuration of a mobile station apparatus according to Embodiment 4;

FIG. 19 is a block diagram showing the configuration of a radio communication system that has a base station apparatus according to Embodiment 5 of the present invention; and

FIG. 20 is a chart showing variations in reception power resource allocation to mobile station apparatuses in Embodiment 5.

### BEST MODE FOR CARRYING OUT THE INVENTION

Embodiments of the present invention will now be described in detail with reference to the accompanying drawings.

### Embodiment 1

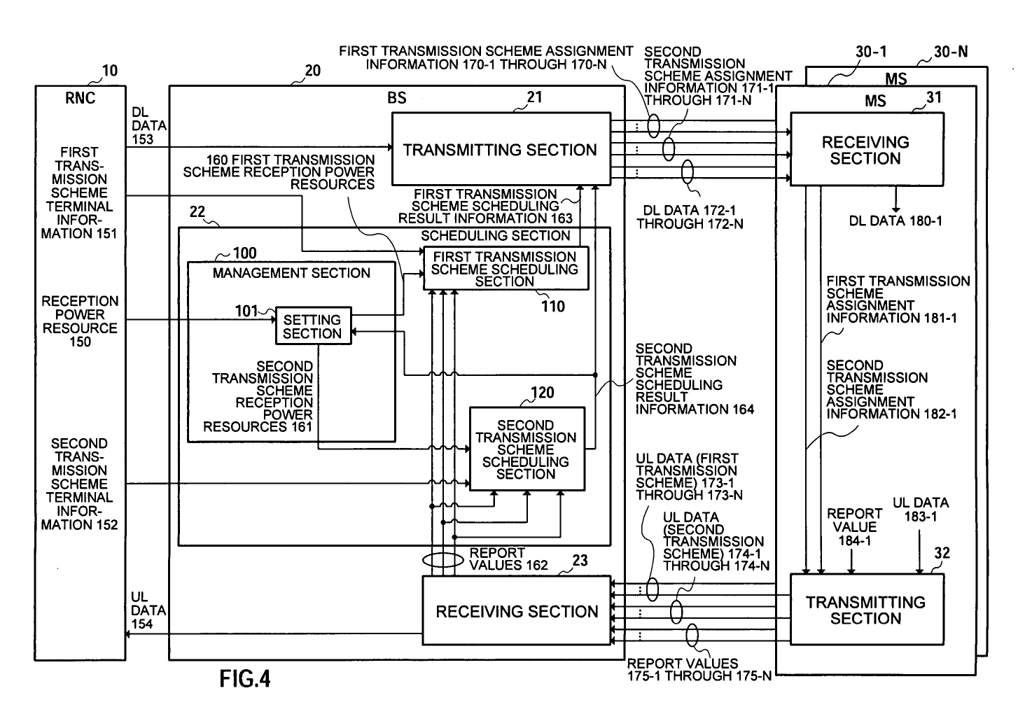

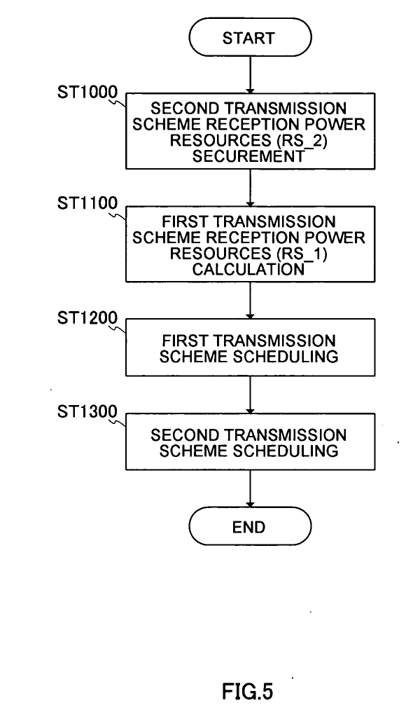

FIG. 4 is a block diagram showing the configuration of a radio communication system that has a BS according to Embodiment 1 of the present invention. It is assumed that two transmission schemes are used for uplink data transmission in a radio communication system according to this embodiment. In this embodiment it is assumed, by way of example, that the first of these two transmission schemes is Time and Rate Scheduling and the second is Rate Scheduling.

The radio communication system shown in FIG. 4 has an RNC 10, a BS 20, and N MSs 30-1, 30-2, . . . , 30-N.

BS 20 has a transmitting section 21, a scheduling section 22, and a receiving section 23.

Transmitting section 21 executes predetermined transmission processing on DL (DownLink) data 153 from RNC 10 in accordance with first transmission scheme scheduling result information 163 and second transmission scheme scheduling result information 164 from scheduling section 22. Then radio signals containing DL data 172-1 through 172-N, first transmission scheme assignment information 170-1 through 170-N, and second transmission scheme assignment information 171-1 through 171-N, are transmitted to MSs 30-1 through 30-N.

In this embodiment it is assumed that first transmission scheme assignment information 170-k is transmitted only to MS 30-k for which data transmission by the first transmission scheme is permitted, and second transmission scheme assignment information 171-h is transmitted only to MS 30-h for which data transmission by the second transmission scheme is permitted.

Receiving section 23 executes predetermined reception processing on first transmission scheme UL (UpLink) data 173-1 through 173-N, second transmission scheme UL data 174-1 through 174-N, and report values 175-1 through 175-N, contained in radio signals transmitted from MSs 30-1 through 30-N. Then receiving section 23 outputs report values 162 obtained as the result of reception processing on report values 175-1 through 175-N to scheduling section 22, and also outputs UL data 154 obtained as the result of reception processing on UL data 173-1 through 173-N and 174-1 through 174-N to RNC 10. Here, report values 175-1 through 175-N include information indicating, for example, available transmission power resources or the amount of data in the transmit buffer, or a combination of these—generally speaking, information relating to uplink data transmission communication conditions—in each of MSs 30-1 through 30-N.

Scheduling section 22 has a management section 100, a first transmission scheme scheduling section 110, and a second transmission scheme scheduling section 120.

Management section 100, which is the principal characteristic part of the present invention, distributes reception power resource 150 set by RNC 10 between first transmission scheme reception power resources 160 and second transmission scheme reception power resources 161. More specifically, management section 100 has a setting section 101 which sets first transmission scheme reception power resources 160 for present scheduling based on reception power resource 150 and past (in this embodiment, previous) second transmission scheme scheduling result information 164 according to second transmission scheme scheduling section 120, and sends this setting to first transmission scheme scheduling section 110. For example, the value of second transmission scheme reception power resources 161 may be set to the value of reception power resources used as the result of the previous scheduling by second transmission scheme scheduling section 120. Then the value obtained by subtracting second transmission scheme reception power resources 161 from reception power resource 150 is set as first transmission scheme reception power resources 160, and this value is output to first transmission scheme scheduling section 110.

By first setting the value of second transmission scheme reception power resources 161 based on past second transmission scheme scheduling result information 164, and then setting the value obtained by subtracting second transmission scheme reception power resources 161 from reception power resource 150 as first transmission scheme reception power resources 160 in this way, it is possible to perform reception power resource setting without making the configuration complex. Also, by setting the value of second transmission scheme reception power resources 161 based on past second transmission scheme scheduling result information 164, the possibility of a large difference arising between set second transmission scheme reception power resources 161 and the reception power resources actually used can be reduced.

Here, provision may also be made for setting section 101 of management section 100 to be able to set the value of second transmission scheme reception power resources 161 to the maximum value that can be used by the second transmission scheme (that is, the reception power resources necessary for the second transmission scheme when a direction is given to raise the transmission rate for all second transmission scheme MSs). In this case, reception power resource distribution can be performed with priority given to the second transmission scheme.

Provision may also be made for setting section 101 of management section 100 to be able to set the value of second transmission scheme reception power resources 161 to the minimum value that can be used by the second transmission scheme (that is, the reception power resources necessary for the second transmission scheme when a direction is given to lower the transmission rate for all second transmission scheme MSs). In this case, reception power resource distribution can be performed with priority given to the first transmission scheme.

First transmission scheme reception power resources 160 may also be allocated so that the second transmission scheme reception power resources 161 value is within the range of the minimum value and maximum value that can be used by the second transmission scheme. In this case it is possible to reduce cases where reception power resources cannot be fully utilized or are insufficient in data transmission based on the second transmission scheme.

First transmission scheme scheduling section 110 performs scheduling for the first transmission scheme in uplink data transmission based on first transmission scheme terminal information 151, first transmission scheme reception power resources 160, and report values 162, and performs reception power resource allocation—that is, transmission rate assignment—to each of MSs 30-1 through 30-N. Then first transmission scheme scheduling result information 163 indicating the scheduling results is output to transmitting section 21. Here, first transmission scheme terminal information 151 is information relating to MSs using the first transmission scheme (such as MS numbers and the number of MSs), and in this embodiment it is assumed that an increase or decrease in the number of MSs, for example, is managed by RNC 10. First transmission scheme scheduling result information 163 indicates MSs for which data transmission by means of the first transmission scheme is permitted, the transmission rate (or transmission power) and transmission timing in data transmission, and so forth.

Second transmission scheme scheduling section 120 performs scheduling for the second transmission scheme in uplink data transmission based on second transmission scheme terminal information 152, second transmission scheme reception power resources 161, and report values 162, and performs reception power resource allocation—that is, transmission rate assignment—to each of MSs 30-1 through 30-N. Then second transmission scheme scheduling result information 164 indicating the scheduling results is output to transmitting section 21. Here, second transmission scheme terminal information 152 is information relating to MSs using the second transmission scheme (such as MS numbers and the number of MSs), and in this embodiment it is assumed that an increase or decrease in the number of MSs, for example, is managed by RNC 10. Second transmission scheme scheduling result information 164 indicates MSs for which data transmission by means of the second transmission scheme is permitted, the transmission rate and transmission timing in data transmission, and so forth.

MS 30-1 has a receiving section 31 and a transmitting section 32. MSs 30-2 through 30-N also have a similar internal configuration to MS 30-1. Therefore, to simplify the explanation, detailed descriptions of the internal configuration and operation will be given only for MS 30-1, and will be omitted for MSs 30-2 through 30-N.

Receiving section 31 executes predetermined reception processing on a radio signal containing either first transmission scheme assignment information 170-1 or second transmission scheme assignment information 171-1, and DL data 172-1. Then receiving section 31 outputs DL data 180-1 obtained as the result of reception processing on DL data 172-1. Receiving section 31 also outputs first transmission scheme assignment information 181-1 and second transmission scheme assignment information 182-1 obtained as the result of reception processing on first transmission scheme assignment information 170-1 or second transmission scheme assignment information 171-1 to transmitting section 32.

Transmitting section 32 executes predetermined transmission processing on UL data 183-1 and report value 184-1 to be transmitted. Then, when first transmission scheme assignment information 181-1 has been input, transmitting section 32 performs uplink data transmission based on the first transmission scheme—that is, transmits a radio signal containing UL data 173-1 to receiving section 23 of BS 20. On the other hand, when second transmission scheme assignment information 182-1 has been input, transmitting section 32 performs uplink data transmission based on the second transmission scheme—that is, transmits a radio signal containing UL data 174-1 to receiving section 23 of BS 20. Transmitting section 32 also sends a radio signal containing report value 175-1 as the result of performing transmission processing report value 184-1 to receiving section 23.

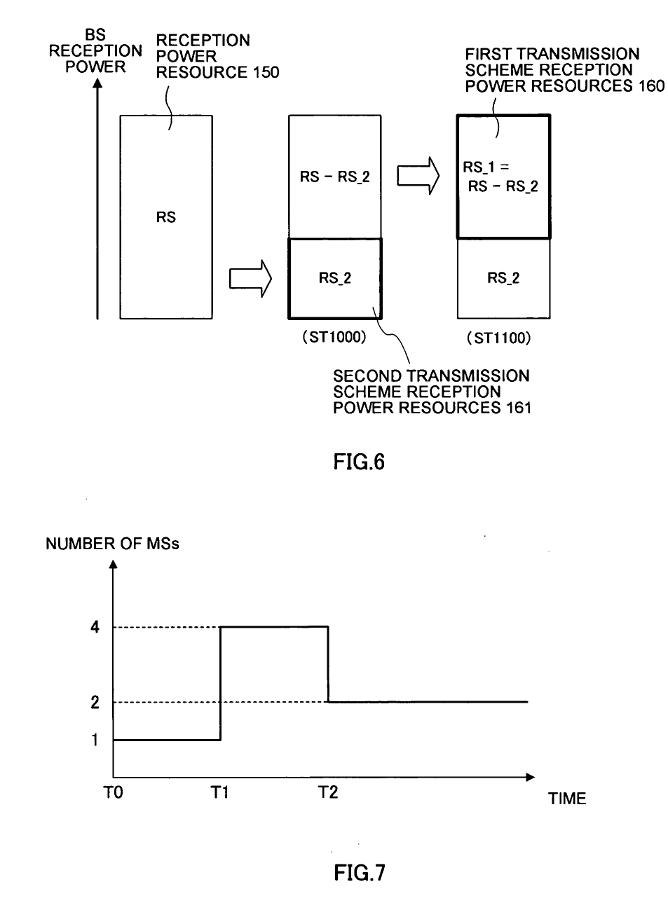

The operation of scheduling section 22 in BS 20 with the above-described configuration will now be explained using FIG. 5 and FIG. 6. FIG. 5 is a flowchart for explaining the operation of scheduling section 22, and FIG. 6 is a drawing showing schematically the process of distributing reception power resource 150.

First, in step ST1000, setting section 101 sets second transmission scheme reception power resources (RS_2) 161 based on previous second transmission scheme scheduling result information 164, and secures second transmission scheme reception power resources (RS_2) 161 in reception power resources (RS) 150 set by RNC 10. Then, in step ST1100, the value of first transmission scheme reception power resources (RS_1) 160 is calculated by subtracting second transmission scheme reception power resources (RS_2) 161 from reception power resources (RS) 150. Next, first transmission scheme scheduling section 110 performs first transmission scheme scheduling (ST1200), and second transmission scheme scheduling section 120 performs second transmission scheme scheduling (ST1300). First transmission scheme scheduling in step ST1200 may be performed at any time after the first transmission scheme reception power resources (RS_1) 160 value has been decided. Similarly, second transmission scheme scheduling in step ST1300 may be performed at any time after the second transmission scheme reception power resources (RS_2) 161 value has been decided.

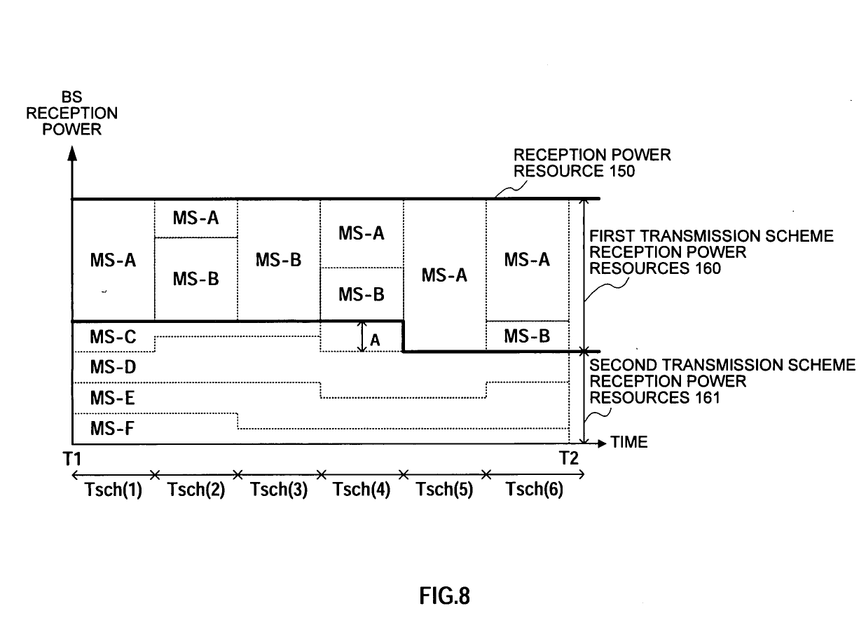

Next, variations in the distribution of reception power resource 150 over time will be described. Here, a case will be described in which the number of MSs using the first transmission scheme does not change from time T0 onward, while the number of MSs using the second transmission scheme varies overtime. More specifically, it is assumed that, as shown in FIG. 7, the number of MSs from time T0 to time T1 is one, the number of MSs from time T1 to time T2 is four, and the number of MSs from time T2 onward is two. The following description will focus in particular on the period from time T1 to time T2. In this period, the number of MSs using the first transmission scheme is assumed to be two—namely, MS-A and MS-B—and the number of MSs using the second transmission scheme is assumed to be four—namely, MS-C, MS-D, MS-E, and MS-F.

FIG. 8 is a chart showing variations in reception power resource allocation to each MS in the period from time T1 to time T2. The period from time T1 to time T2 is made up of scheduling periods Tsch(1) through Tsch(6).

As shown in FIG. 8, the total of the reception power resources allocated to MS-C through MS-F as the result of scheduling period Tsch(3) scheduling (that is, second transmission scheme reception power resources 161 in scheduling period Tsch(3)) is second transmission scheme reception power resources 161 of scheduling period Tsch(4). Also, the total of the reception power resources allocated to MS-C through MS-F as the result of scheduling period Tsch(4) scheduling is second transmission scheme reception power resources 161 of scheduling period Tsch(5).

The point to be noted here is that, in scheduling period Tsch (4), the reception power resources actually allocated to MS-C through MS-F are lower by amount A than second transmission scheme reception power resources 161. Therefore, in scheduling period Tsch(5), second transmission scheme reception power resources 161 are lower than in scheduling period Tsch(4). As a result, first transmission scheme reception power resources 160 in scheduling period Tsch(5) increase.

Thus, when there is a sufficient amount of UL data in MS-A or MS-B, increase A in first transmission scheme reception power resources 160 can be used effectively for transmission of that UL data. In other words, it is possible to reduce the frequency of occurrence of a situation in which there are insufficient reception power resources for one transmission scheme and surplus reception power resources for the other transmission scheme. In this way, reception power resource distribution according to this embodiment makes it possible to track variations in reception power resource allocation on an individual scheduling period basis.

As setting of reception power resource 150 and management of an increase or decrease in the number of MSs are often performed by RNC 10, it is also possible for reception power resource distribution to be performed by RNC 10. However, even if reception power resource distribution in line with only an increase or decrease in the number of MSs is performed by RNC 10, distribution of reception power resource 150 cannot be said to be controlled flexibly. This is because the amount of reception power resources actually allocated to MSs 30-1 through 30-N is affected by the conditions of the communications with MSs 30-1 through 30-N.

However, it is not easy for RNC 10 to immediately ascertain report values 162 containing information relating to communication conditions or the results of scheduling by scheduling section 22 based on those report values 162. Generally, a scheduling cycle is extremely short, at approximately several ms to several tens of ms, compared with a delay of several hundred ms in signaling between the RNC and a BS. In this embodiment, the use of scheduling section 22 in BS 20 enables reception power resource distribution to be dependably synchronized with the scheduling cycle, and distribution control to be performed flexibly. Furthermore, assuming that distribution is performed by RNC 10, an increase in the amount of signaling between the RNC and a BS, and in the load on RNC 10, can be expected. With this embodiment, on the other hand, there is no risk of an increase in the amount of signaling between the RNC and a BS since distribution is performed by BS 20.

Thus, according to this embodiment, reception power resource 150 set by RNC 10 is distributed to a plurality of transmission schemes by BS 20 taking report values 162 into consideration, enabling reception power resource distribution among a plurality of transmission schemes to be controlled speedily and flexibly, making it possible to improve the utilization efficiency of reception power resource 150, and enabling user throughput and system throughput to be improved in a radio communication system.

### Embodiment 2

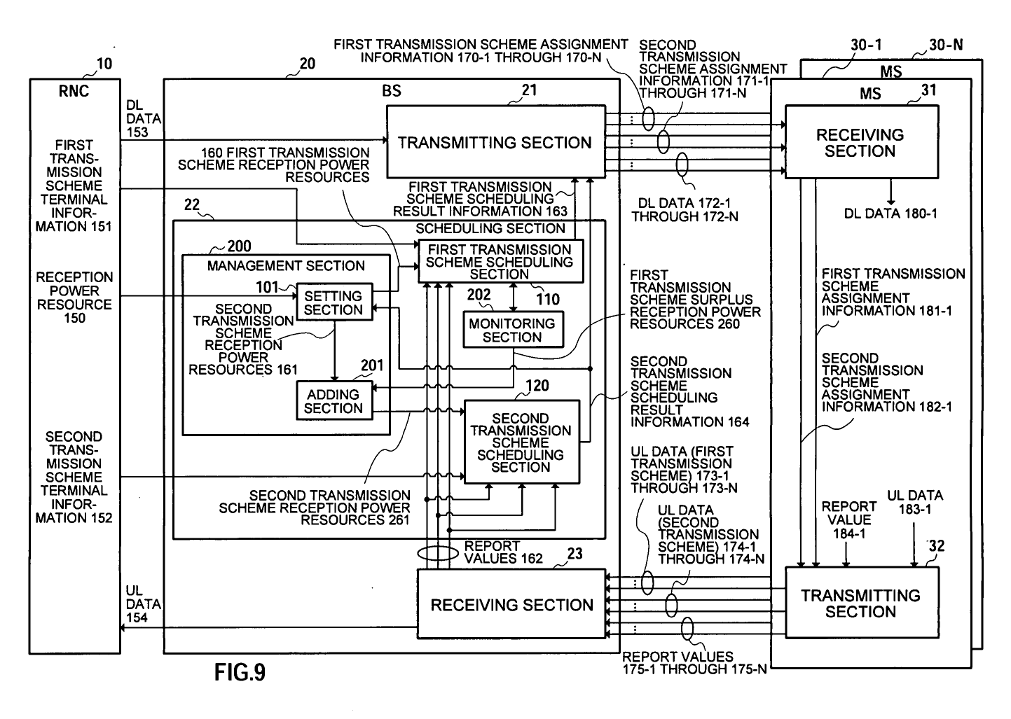

FIG. 9 is a block diagram showing the configuration of a radio communication system that has a BS 20 according to Embodiment 2 of the present invention. It is assumed that two transmission schemes are used for uplink data transmission in a radio communication system according to this embodiment, as in the above-described embodiment. In this embodiment it is assumed, by way of example, that the first of these two transmission schemes is Time and Rate Scheduling and the second is Rate Scheduling. The radio communication system described in this embodiment has the same basic configuration as the radio communication system described in Embodiment 1, and therefore identical or corresponding configuration elements are assigned the same reference codes, and detailed descriptions thereof are omitted.

Scheduling section 22 of this embodiment has a management section 200 instead of management section 100 described in Embodiment 1. Management section 200 has an adding section 201 in addition to setting section 101. Scheduling section 22 also has a monitoring section 202.

The principal characteristic of this embodiment is that, when a surplus of reception power resources occurs in first transmission scheme scheduling, that surplus is added to the reception power resources of the second transmission scheme.

The second transmission scheme reception power resources 161 value set by setting section 101 is sent to adding section 201.

Monitoring section 202 monitors the occurrence of a surplus of reception power resources due to scheduling by first transmission scheme scheduling section 110. When a surplus occurs, monitoring section 202 calculates the surplus amount and sends at least a part thereof (hereinafter referred to as “first transmission scheme surplus reception power resources 260”) to adding section 201.

Adding section 201 calculates the sum of second transmission scheme reception power resources 161 and first transmission scheme surplus reception power resources 260, and outputs the calculation result, second transmission scheme reception power resources 261, to second transmission scheme scheduling section 120.

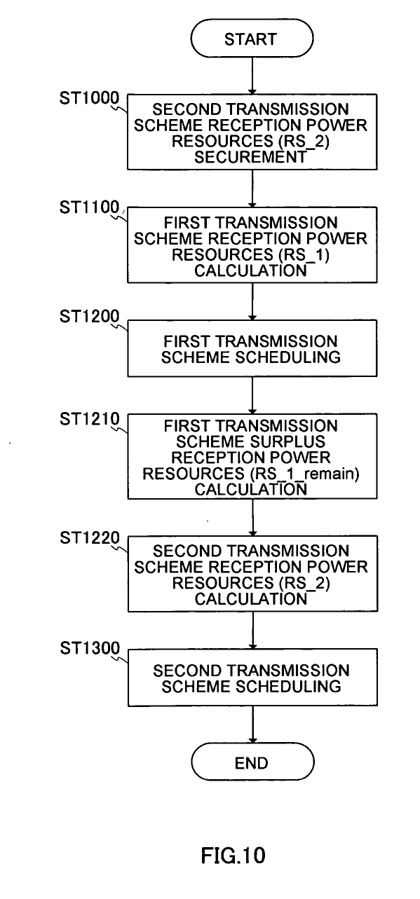

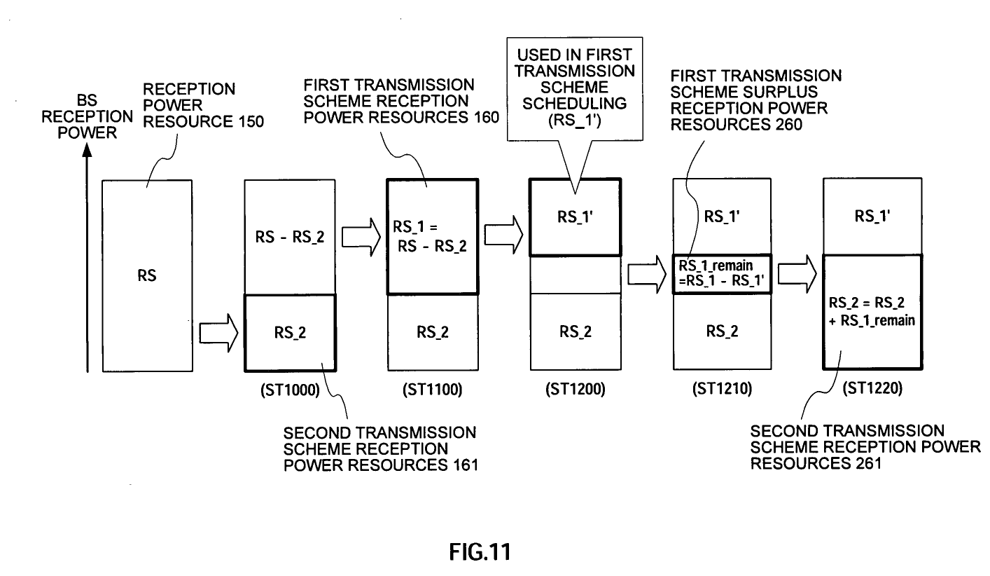

The operation of scheduling section 22 in BS 20 with the above-described configuration will now be explained using FIG. 10 and FIG. 11. FIG. 10 is a flowchart for explaining the operation of scheduling section 22, and FIG. 11 is a drawing showing schematically the process of distributing reception power resource 150.

Following the execution of step ST1000 through step ST1200 described in Embodiment 1, in step ST1210 monitoring section 202 subtracts the reception power resources (RS_1′) used in first transmission scheme scheduling in step ST1200 from first transmission scheme reception power resources (RS_1) 160. By this means, the value of first transmission scheme surplus reception power resources (RS_1_remain) 260 is calculated. Then, in step ST1220, the value of first transmission scheme surplus reception power resources (RS_1_remain) 260 is added to second transmission scheme reception power resources (RS_2) 161. By this means, the value of second transmission scheme reception power resources (RS_2) 261 is calculated. The processing flow then proceeds to step ST1300 described in Embodiment 1.

First transmission scheme scheduling in step ST1200 may be performed at any time after the first transmission scheme reception power resources (RS_1) 160 value has been decided.

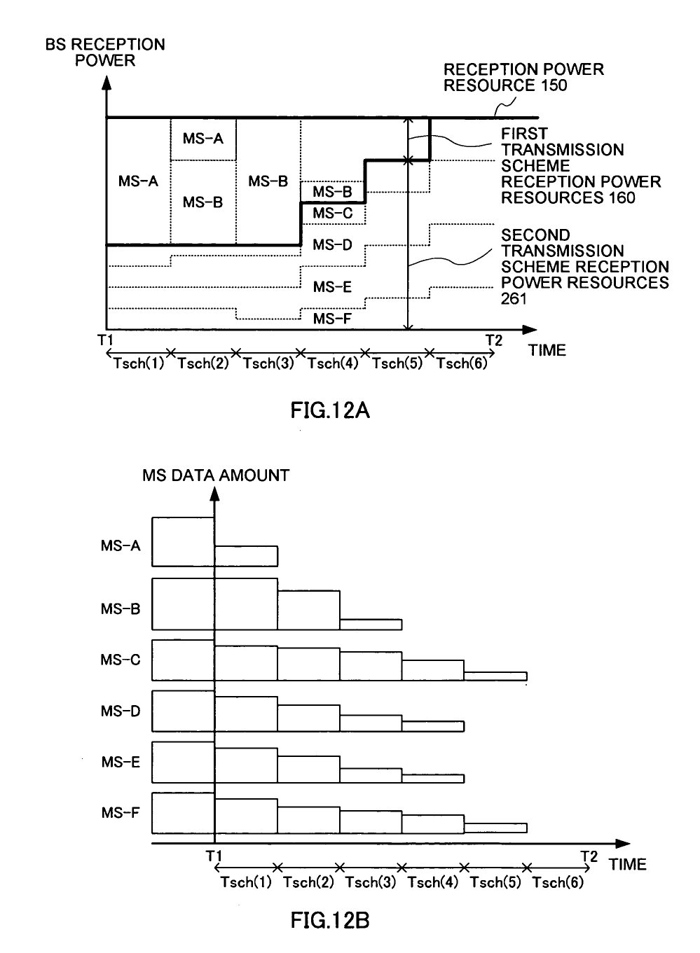

Next, variations in the distribution of reception power resource 150 over time will be described using FIG. 12A and FIG. 12B. FIG. 12A is a chart showing variations in reception power resource allocation to each MS, and FIG. 12B is a chart showing variations in the amount of data in each MS. Here, as in Embodiment 1, the period from time T1 to time T2 will be focused on. That is to say, MSs using the first transmission scheme are MS-A and MS-B, and MSs using the second transmission scheme are MS-C, MS-D, MS-E, and MS-F.

As shown in FIG. 12B, in scheduling period Tsch(3) there is no longer any data in MS-A and the amount of data in MS-B decreases markedly. In line with this, as shown in FIG. 12A, in scheduling period Tsch(4) there are no longer any reception power resources allocated to MS-A and reception power resources allocated to MS-B decrease markedly. As a result, a surplus occurs in first transmission scheme reception power resources 160 of scheduling period Tsch(4). In a case such as this, redistribution of reception power resource 150 can be performed by adding at least part of this surplus to second transmission scheme reception power resources 161. In FIG. 12A and FIG. 12B a case is illustrated in which first transmission scheme reception power resources 160 are decreased with time, but increasing first transmission scheme reception power resources 160 with time can also be implemented in a similar way.

In scheduling periods Tsch(4) and Tsch(5), the reason why there is a part of the first transmission scheme reception power resources 160 surplus that cannot be redistributed to the second transmission scheme is that Rate Scheduling is assumed to be used as the second transmission scheme. That is to say, even when a direction is given to raise the transmission rates for all MSs by one step, for example, there is a limit to the reception power resources that can be fully utilized by the second transmission scheme. Therefore, if a transmission scheme with no (or loose) limits on transmission rate increases or decreases stipulated for MSs is used, the above kind of situation can be avoided and the utilization efficiency of reception power resource 150 can be significantly increased.

Thus, according to this embodiment, at least a part of a surplus of first transmission scheme reception power resources 160 produced as a result of scheduling by first transmission scheme scheduling section 110 is added to second transmission scheme reception power resources 161 as first transmission scheme surplus reception power resources 260, enabling surplus reception power resources in one transmission scheme to be redistributed to the other transmission scheme, and making it possible to further improve the utilization efficiency of reception power resource 150.

### Embodiment 3

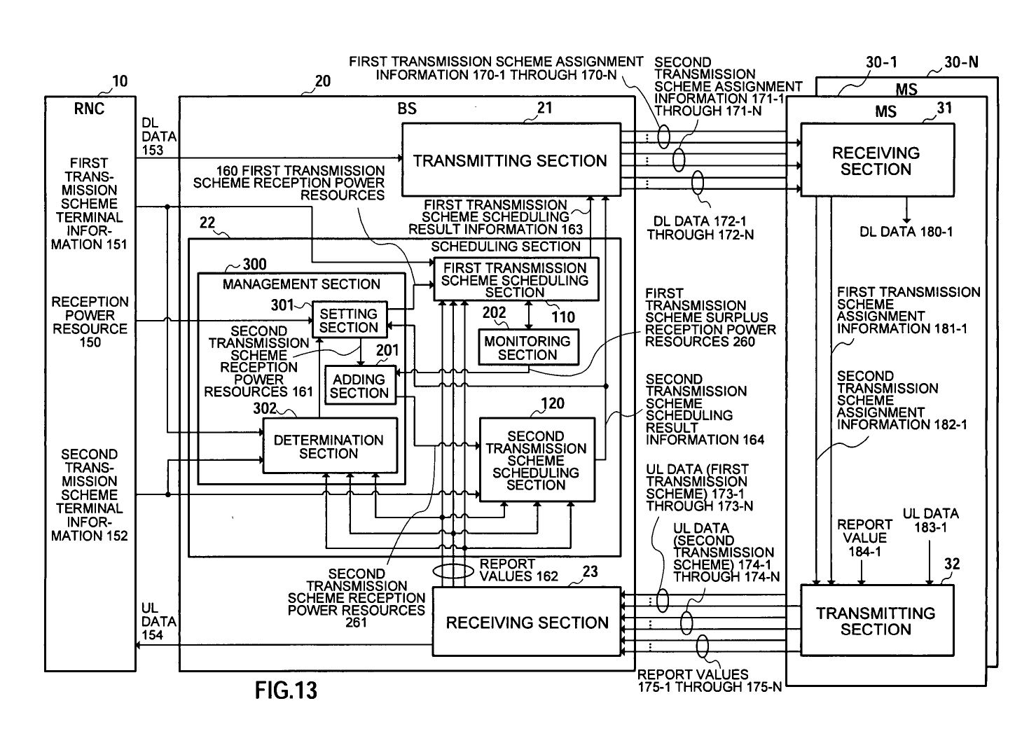

FIG. 13 is a block diagram showing the configuration of a radio communication system that has a BS 20 according to Embodiment 3 of the present invention. It is assumed that two transmission schemes are used for uplink data transmission in a radio communication system according to this embodiment, as in the above-described embodiments In this embodiment it is assumed, by way of example, that the first of these two transmission schemes is Time and Rate Scheduling and the second is Rate Scheduling. The radio communication system described in this embodiment has the same basic configuration as the radio communication system described in Embodiment 2, and therefore identical or corresponding configuration elements are assigned the same reference codes, and detailed descriptions thereof are omitted.

Scheduling section 22 of this embodiment has a management section 300 instead of management section 200 described in Embodiment 2. In addition to adding section 201, management section 300 has a setting section 301 instead of setting section 101, and also has a determination section 302.

The principal characteristic of this embodiment is that reception power resource distribution is performed taking particular account of variations in the amount of data among report values from MSs 30-1 through 30-N to BS 20. Data amount information may be the amount of data in the transmit buffer of an MS or an indirect value such as the requested transmission rate, or may be an absolute value, relative value, difference value (such as UP/DOWN/KEEP, for example), or other value.

Determination section 302 determines whether first transmission scheme reception power resources 160 or second transmission scheme reception power resources 161 are to be increased or decreased based on first transmission scheme terminal information 151, second transmission scheme terminal information 152, and report values 162.

For example, of the information indicated by report values 162, the amount of data of MSs that use the first transmission scheme may be referenced. Then, if, for example, a marked increasing or decreasing trend is seen or predicted in the amount of data of the first transmission scheme, determination section 302 determines an increase or decrease of first transmission scheme reception power resources 160 before data transmission based on the first transmission scheme is completed, and indicates this to setting section 301. Determination section 302 may also indicate not only an increase or decrease of first transmission scheme reception power resources 160 but also the amount of increase/decrease or rate of increase/decrease.

On receiving an instruction from determination section 302, setting section 301 performs distribution of reception power resource 150 in accordance with that instruction. For example, if an instruction for reduction of first transmission scheme reception power resources 160 is given by determination section 302, an additional amount is given to second transmission scheme reception power resources 161 in the stage in which second transmission scheme reception power resources are secured. Other operations executed by setting section 301 are the same as in the case of setting section 101.

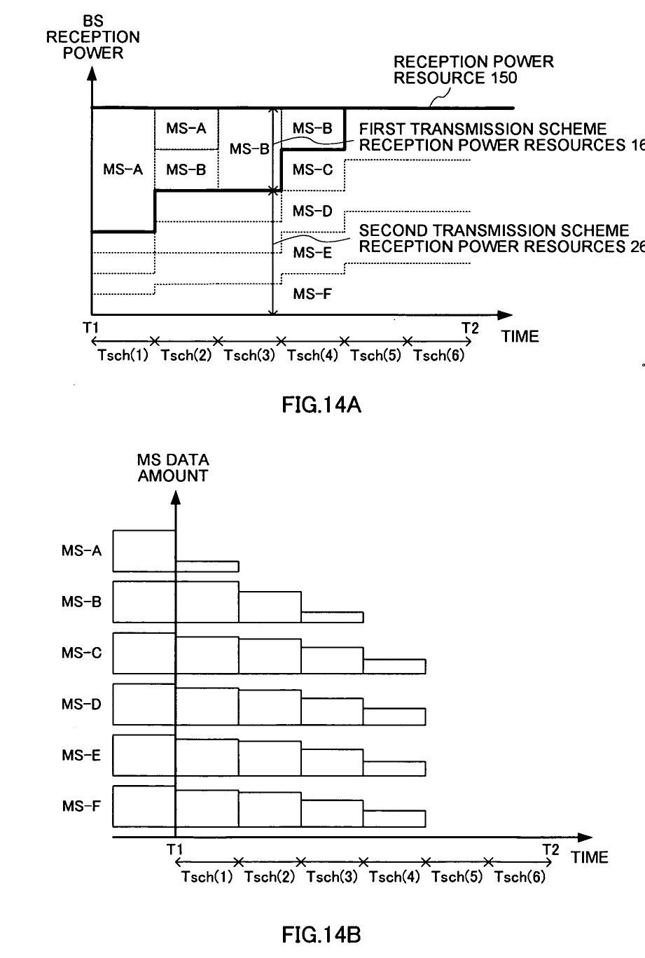

Next, variations in the distribution of reception power resource 150 over time will be described using FIG. 14A and FIG. 14B. FIG. 14A is a chart showing variations in reception power resource allocation to each MS, and FIG. 14B is a chart showing variations in the amount of data in each MS. Here, as in the above-described embodiments, the period from time T1 to time T2 will be focused on. That is to say, MSs using the first transmission scheme are MS-A and MS-B, and MSs using the second transmission scheme are MS-C, MS-D, MS-E, and MS-F.

In the example shown here, first transmission scheme reception power resources 160 are reduced in each of scheduling periods Tsch(2), Tsch(4), and Tsch(5). In scheduling period Tsch(2), in particular, first transmission scheme reception power resources 160 can be reduced and second transmission scheme reception power resources 261 can be increased even before both MS-A and MS-B data transmissions are completed. In FIG. 14A and FIG. 14B a case is illustrated in which first transmission scheme reception power resources 160 are decreased with time, but increasing first transmission scheme reception power resources 160 with time can also be implemented in a similar way.

Thus, according to this embodiment, reception power resource distribution is performed taking particular account of variations in the amount of data among report values 162 containing information reported from MSs 30-1 through 30-N to BS 20, so that, as long as there is a sufficient amount of transmit data, the probability of being able to fully utilize reception power resource 150 at all times can be greatly improved. Furthermore, it is possible to keep extension of a first transmission scheme data transmission period to a minimum level and raise the second transmission scheme transmission rate.

### Embodiment 4

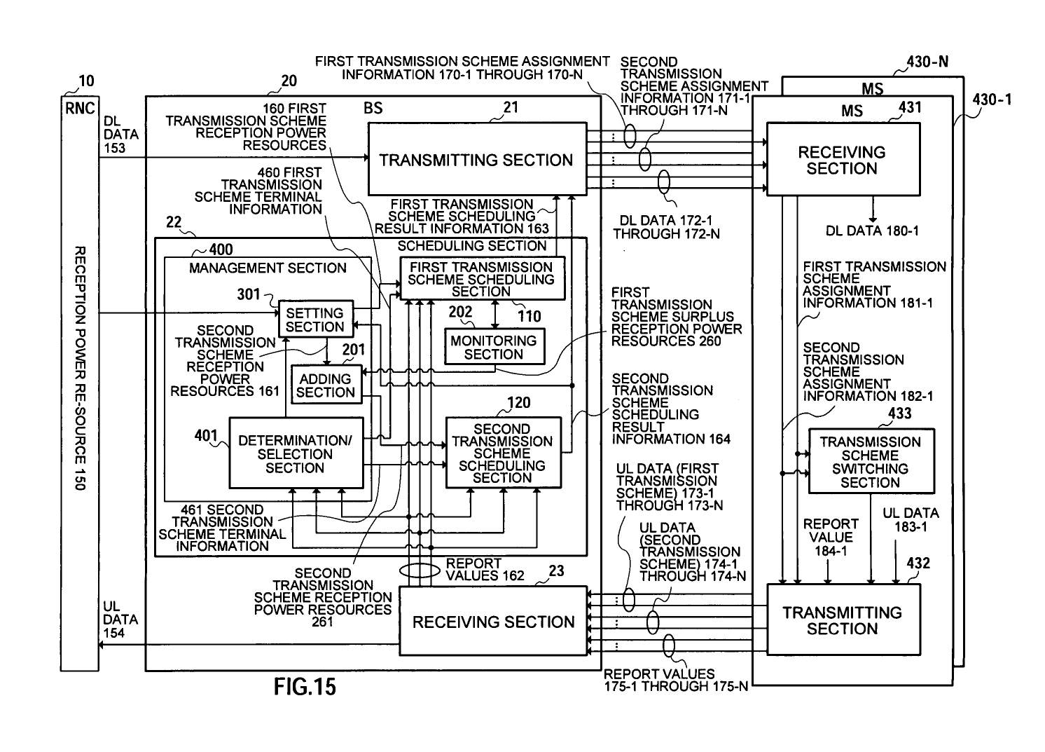

FIG. 15 is a block diagram showing the configuration of a radio communication system that has a BS 20 according to Embodiment 4 of the present invention. It is assumed that two transmission schemes are used for uplink data transmission in a radio communication system according to this embodiment, as in the above-described embodiments. As an example of this embodiment, it is assumed that the first of these two transmission schemes is Time and Rate Scheduling and the second is Rate Scheduling. The radio communication system described in this embodiment has the same basic configuration as the radio communication system described in Embodiment 3, and therefore identical or corresponding configuration elements are assigned the same reference codes, and detailed descriptions thereof are omitted.

Scheduling section 22 of this embodiment has a management section 400 instead of management section 300 described in Embodiment 3. Management section 400 has a determination/selection section 401 instead of determination section 302.

A radio communication system according to this embodiment has MSs 430-1 through 430-N instead of MSs 30-1 through 30-N. The internal configuration of MSs 430-1 through 430-N will be described in detail later herein.

The principal characteristic of this embodiment is that not only distribution of reception power resources to a plurality of transmission schemes, but also switching among a plurality of transmission schemes, is performed by BS 20.

Determination/selection section 401 decides first transmission scheme terminal information 460 and second transmission scheme terminal information 461 based on report values 162. In other words, determination/selection section 401 selects the transmission scheme to be used by MSs 430-1 through 430-N from the first transmission scheme and the second transmission scheme. When combined use of the two transmission schemes is possible, determination/selection section 401 decides use or non-use (the on/off status) of each transmission scheme for each MS.

That is to say, whereas in the above-described embodiments first transmission scheme terminal information 151 and second transmission scheme terminal information 152 were sent from RNC 10, in this embodiment first transmission scheme terminal information 460 and second transmission scheme terminal information 461 are decided within BS 20. The decided first transmission scheme terminal information 460 and second transmission scheme terminal information 461 are output to first transmission scheme scheduling section 110 and second transmission scheme scheduling section 120 respectively. Other operations executed by determination/selection section 401 are the same as in the case of determination section 302. That is to say, determination/selection section 401 determines whether first transmission scheme reception power resources 160 or second transmission scheme reception power resources 161 are to be increased or decreased. Determination/selection section 401 may also indicate the amount of increase/decrease or rate of increase/decrease.

Next, two examples will be given of transmission scheme switching operations by BS 20 with the above-described configuration. One is switching according to the amount of data of MSs 430-1 through 430-N, and the other is switching according to the transmission power resources of MSs 430-1 through 430-N. Here, as in the above-described embodiments, the period from time T1 to time T2 will be focused on. In this embodiment, since the first transmission scheme is Time and Rate Scheduling and downlink signaling uses multiple bits, it is assumed that the number of MSs for which the first transmission scheme is permitted simultaneously is limited to two.

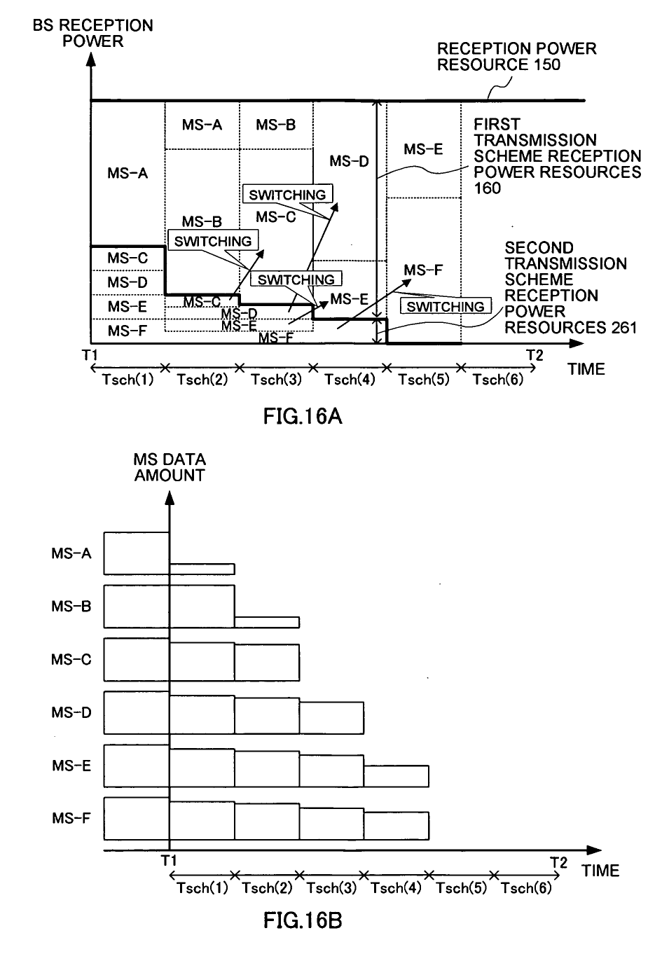

First, switching operations according to the amount of data will be described. FIG. 16A is a chart showing transmission scheme switching according to the amount of data in MSs, and FIG. 16B is a chart showing variations in the amount of data in MSs.

In scheduling period Tsch(2), MS-A completes data transmission. Therefore, in scheduling period Tsch(3), MS-C is switched from the second transmission scheme to the first transmission scheme. Similarly, in scheduling period Tsch(3), MS-B and MS-C complete data transmission, and therefore, in scheduling period Tsch(4), MS-D and MS-E are switched from the second transmission scheme to the first transmission scheme.

This switching may also be performed based on predetermined priorities. Examples of priority criteria that can be used include report values such as MS data amount or transmission power resources, data retention time in an MS, past user throughput, and delay time. In this case, reception power resource 150 can be used effectively, and data transmission can be performed after switching to the first transmission scheme—that is, the transmission scheme with a high transmission rate—in order starting with the highest-priority MS.

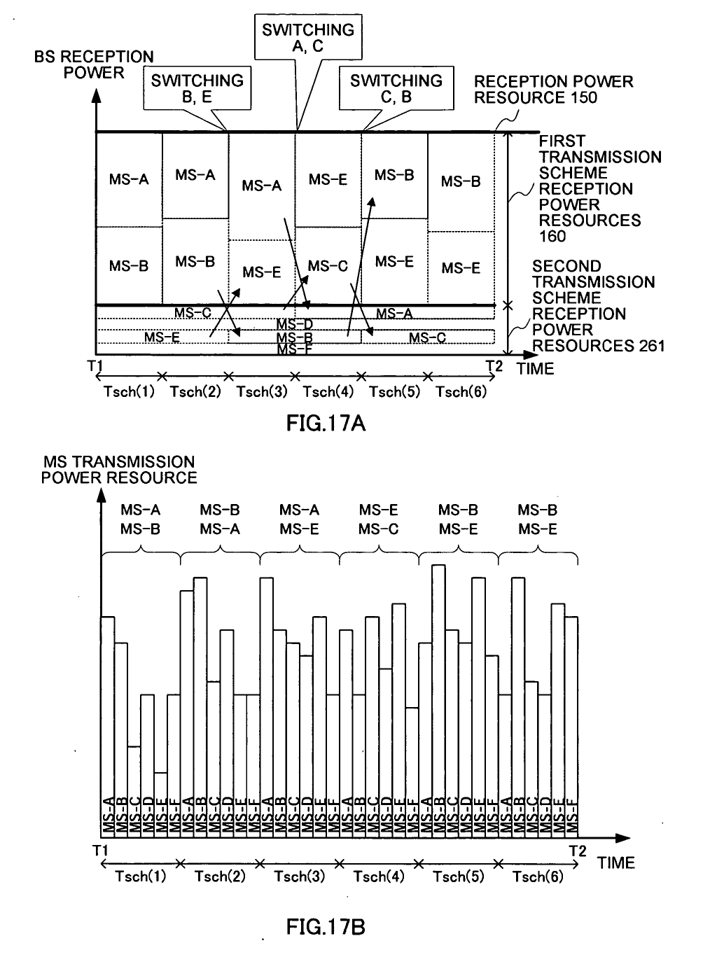

Next, switching operations according to reception power resources will be described. FIG. 17A is a chart showing transmission scheme switching according to transmission power resources in MSs, and FIG. 17B is a chart showing variations in transmission power resources in MSs. For the sake of simplicity, it will be assumed in the following description that the reception power resources of each second transmission scheme MS are the same.

In the example shown in FIG. 17A and FIG. 17B, information relating to transmission power resources of MSs 430-1 through 430-N among information contained in report values 162 is referenced. Then control is performed so that the first transmission scheme is applied to the two topmost MSs in terms of size of transmission power resources.

In scheduling period Tsch(1) and Tsch(2), MS-A and MS-B are the two topmost MSs in terms of transmission power resources, and therefore MS-A and MS-B perform data transmission by means of the first transmission scheme. The two topmost MSs change to MS-A and MS-E in scheduling period Tsch(3), to MS-E and MS-C in scheduling period Tsch(4), and to MS-B and MS-E in scheduling period Tsch(5). Therefore, the MSs for which the first transmission scheme is permitted also change in each of these periods. Having large reception power resources means that reception is possible even if data transmission is performed at low transmission power—in other words, that propagation path conditions are good.

In this example, since the first transmission scheme can be permitted preferentially for an MS whose propagation path conditions are good, it is possible for an MS for which this is permitted to perform data transmission at a high transmission rate. Also, as low transmission power is sufficient, interference with other BSs can be reduced, and system throughput can be significantly improved. Moreover, as changing MSs for which the first transmission scheme is permitted enables an MS with good propagation path conditions to perform data transmission at a high transmission rate, a multi-user diversity effect is obtained and system throughput can be increased.

Next, the configuration of MSs 430-1 through 430-N that perform radio communication with BS 20 will be described. An arbitrary MS among MSs 430-1 through 430-N will be referred to as MS 430.

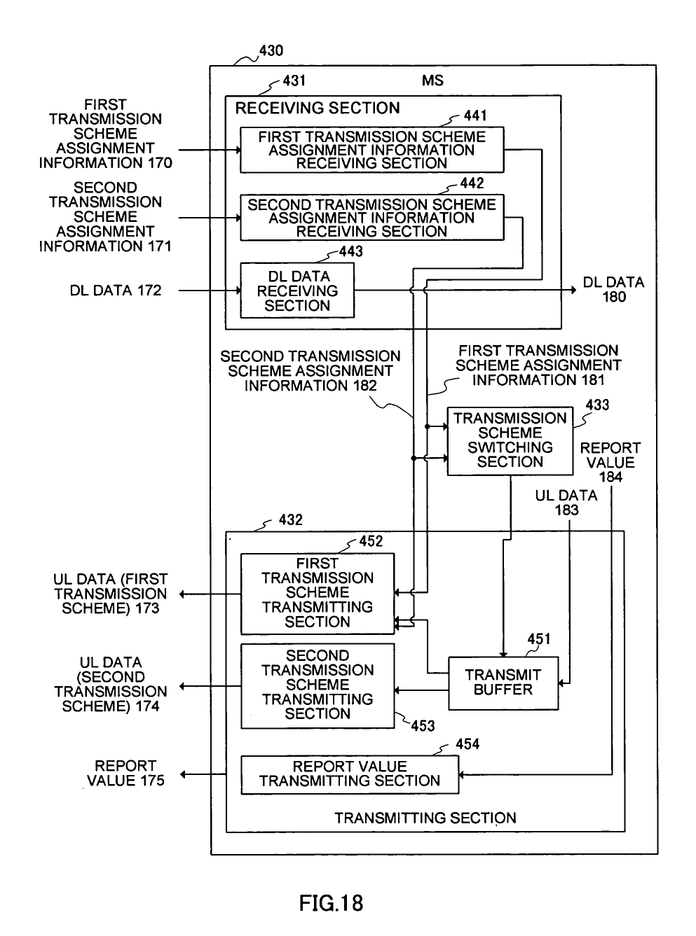

FIG. 18 is a block diagram showing the configuration of MS 430. MS 430 has a receiving section 431, a transmitting section 432, and a transmission scheme switching section 433.

Receiving section 431 has a first transmission scheme assignment information receiving section 441, a second transmission scheme assignment information receiving section 442, and a DL data receiving section 443. Transmitting section 432 has a transmit buffer 451, a first transmission scheme transmitting section 452, a second transmission scheme transmitting section 453, and a report value transmitting section 454.

First transmission scheme assignment information receiving section 441 demodulates first transmission scheme assignment information 170, then performs determination of whether or not signaling for this apparatus has been received, and if such signaling has been received, extracts first transmission scheme assignment information 181, and outputs extracted first transmission scheme assignment information 181 to transmission scheme switching section 433 and transmitting section 432.

Second transmission scheme assignment information receiving section 442 demodulates second transmission scheme assignment information 171, then performs determination of whether or not signaling for this apparatus has been received, and if such signaling has been received, extracts second transmission scheme assignment information 182, and outputs extracted second transmission scheme assignment information 182 to transmission scheme switching section 433 and transmitting section 432.

DL data receiving section 443 demodulates DL data 172 and outputs DL data 180.

If first transmission scheme assignment information 181 has been input, transmission scheme switching section 433 notifies transmit buffer 451 that first transmission scheme data transmission is permitted, and also reports the permitted transmission rate or the maximum value thereof. If second transmission scheme assignment information 182 has been input, transmission scheme switching section 433 notifies transmit buffer 451 that second transmission scheme data transmission is permitted, and also reports the permitted transmission rate.

Transmit buffer 451 outputs UL data 183 to first transmission scheme transmitting section 452 or second transmission scheme transmitting section 453 according to the presence or absence of notification from transmission scheme switching section 433.

First transmission scheme transmitting section 452 modulates UL data 183 and transmits resulting UL data 173 in conformity with the first transmission scheme.

Second transmission scheme transmitting section 453 modulates UL data 183 and transmits resulting UL data 174 in conformity with the second transmission scheme.

Report value transmitting section 454 modulates report value 184 and transmits the result as report value 175.

Having the above-described configuration enables MS 430 to switch the transmission scheme in accordance with a signal from BS 20.

In this embodiment, the transmission scheme is switched according to whether first transmission scheme assignment information 181 or second transmission scheme assignment information 182 is received. However, the switching scheme is not limited to this. For example, the transmission scheme may be switched based on whether or not first transmission scheme assignment information 170 is received or whether or not second transmission scheme assignment information 171 is received—that is, based on signaling on the BS 20 side. Also, if a radio communication system according to this embodiment is a system that allows combined use of two transmission schemes, MS 430 may perform data transmission using both transmission schemes when there are sufficient transmission power resources.

Thus, according to this embodiment, not only distribution of reception power resources to a plurality of transmission schemes, but also switching among a plurality of transmission schemes, is performed by BS 20, making it possible, for example, to switch the transmission scheme so that a transmission scheme with a high transmission rate is applied to a high-priority MS or an MS with good propagation path conditions, and moreover enabling switching control to be performed at high speed in the same way as reception power resource distribution control, thereby making it possible to give priority to an MS with stringent delay requirements, and also enabling user throughput and system throughput to be significantly improved.

### Embodiment 5

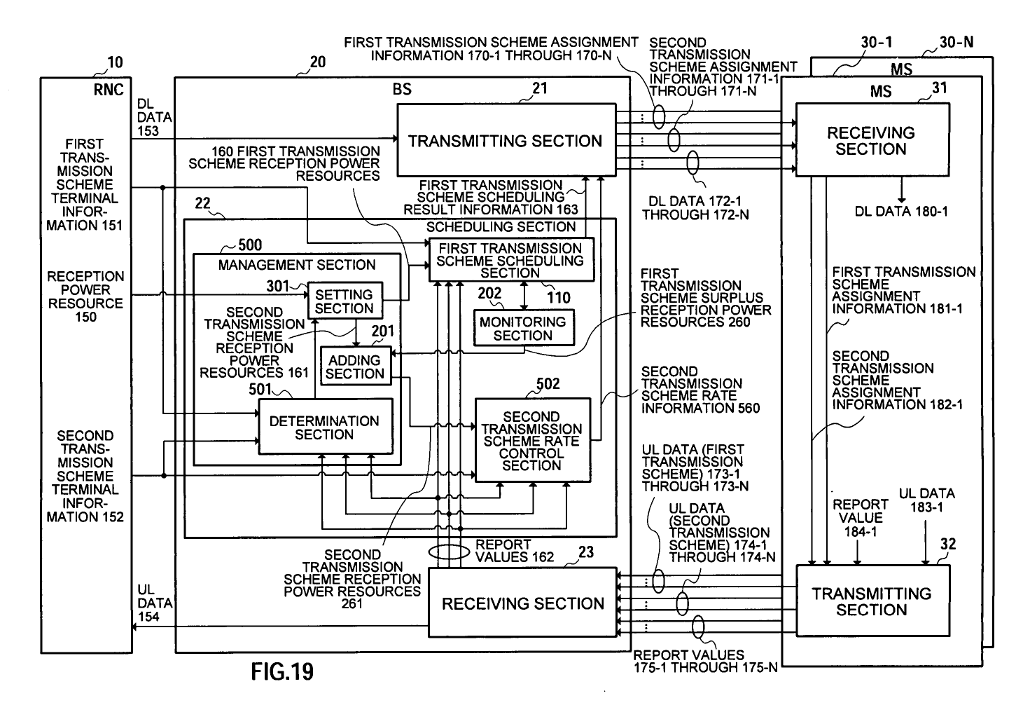

FIG. 19 is a block diagram showing the configuration of a radio communication system that has a BS 20 according to Embodiment 5 of the present invention. It is assumed that two transmission schemes are used for uplink data transmission in a radio communication system according to this embodiment, as in the above-described embodiments, but in this embodiment, by way of example, Autonomous Transmission is used as the second transmission scheme. The radio communication system described in this embodiment has the same basic configuration as the radio communication system described in Embodiment 3, and therefore identical or corresponding configuration elements are assigned the same reference codes, and detailed descriptions thereof are omitted.

Scheduling section 22 of this embodiment has a management section 500 instead of management section 200, and has a second transmission scheme rate control section 502 instead of second transmission scheme scheduling section 120. Management section 500 has a setting section 301, adding section 201, and a determination section 501 that determines an increase or decrease in the reception power resources that may be used by the first transmission scheme in the same way as determination section 302 based on first transmission scheme terminal information 151 and second transmission scheme terminal information 152.

The principal characteristic of this embodiment is that reception power resource distribution is performed by BS 20 in a radio communication system that uses Autonomous Transmission as one of a plurality of transmission schemes.

Second transmission scheme rate control section 502 divides second transmission scheme reception power resources 261 by the number of MSs based on second transmission scheme terminal information 152. By this means, reception power resources per MS are calculated. Second transmission scheme rate control section 502 also calculates the transmission rate and outputs this to transmitting section 21 as second transmission scheme rate information 560. As second transmission scheme rate information 560 is information common to two or more applicable MSs, although performing different control for each MS is difficult, the amount of signaling in downlinks can be reduced. Also, if second transmission scheme MSs are grouped beforehand, transmission rate control can be performed on a group-by-group basis.

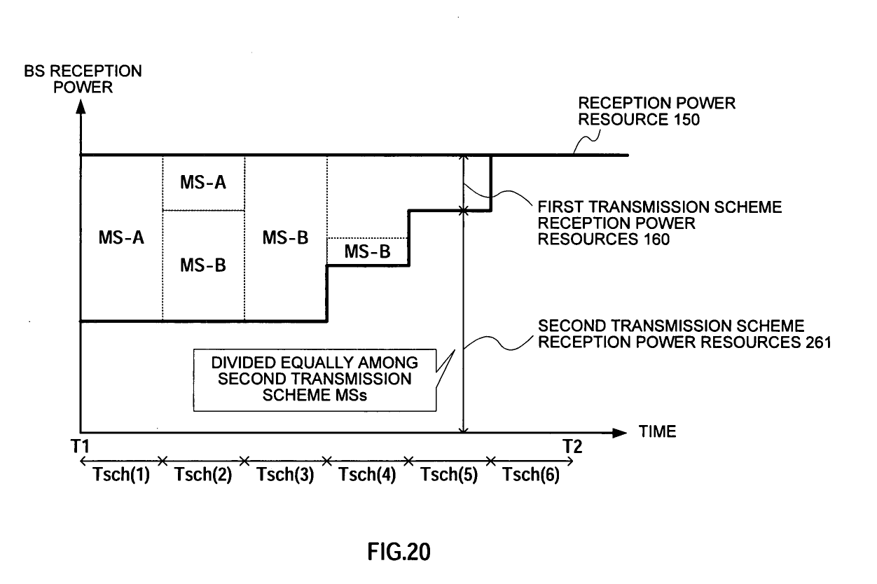

Next, variations in the distribution of reception power resource 150 over time will be described using FIG. 20. FIG. 20 is a chart showing variations in reception power resource allocation to each MS. Here, as in the above-described embodiments, the period from time T1 to time T2 will be focused on. In this embodiment, the number of MSs using the first transmission scheme is two (MS-A and MS-B), and the number of MSs using the second transmission scheme is not specified, but is more than one.

As shown in FIG. 20, when a surplus occurs in first transmission scheme reception power resources 160, that surplus can be redistributed to second transmission scheme reception power resources. Second transmission scheme reception power resources 261 are divided equally among second transmission scheme MSs.

Thus, according to this embodiment, reception power resource distribution is performed by BS 20 in a radio communication apparatus that uses Autonomous Transmission as one of a plurality of transmission schemes, making it possible to perform reception power resource distribution control at high speed, and thereby enabling priority to be given to an MS with stringent delay requirements, and also enabling user throughput and system throughput to be significantly improved. In this embodiment, Time and Rate Scheduling has been described as the first transmission scheme by way of example, but implementation is also possible with a different scheduling scheme, such as Rate Scheduling.

### Other Embodiments

In the above embodiments a radio communication system that uses two transmission schemes has been described, but it is also possible to perform reception power resource distribution and transmission scheme switching in a similar way in a radio communication system that uses three or more transmission schemes. Also, three transmission schemes—Time and Rate Scheduling, Rate Scheduling, and Autonomous Transmission—have been described by way of example, but implementation is also possible with transmission schemes other than these as long as at least two transmission schemes are combined. For example, implementation is also possible when a transmission scheme in which a BS performs scheduling for an E-DCH (Enhanced-Dedicated Channel) and a transmission scheme in which scheduling is not performed for an E-DCH by a BS are combined. An E-DCH is a channel used in uplink enhancement.

The channel subject to scheduling need not be limited to an E-DCH. For example, implementation is also possible when a transmission scheme in which a BS performs scheduling for an E-DCH and a transmission scheme in which a superordinate apparatus (for example, an RNC) controls the upper limit of the transmission rate of a conventional DCH (Dedicated Channel) are combined.

Implementation is also possible when a transmission scheme in which a BS performs scheduling for an E-DCH, a transmission scheme in which a BS does not perform scheduling for an E-DCH, and a transmission scheme in which a superordinate apparatus controls the upper limit of the transmission rate of a DCH, are combined.

A mode can also be imagined in which at least two transmission schemes are combined and called one transmission scheme, in which case implementation is possible in a similar way as long as operations such as internal transmission power resource distribution or transmission scheme switching are included.

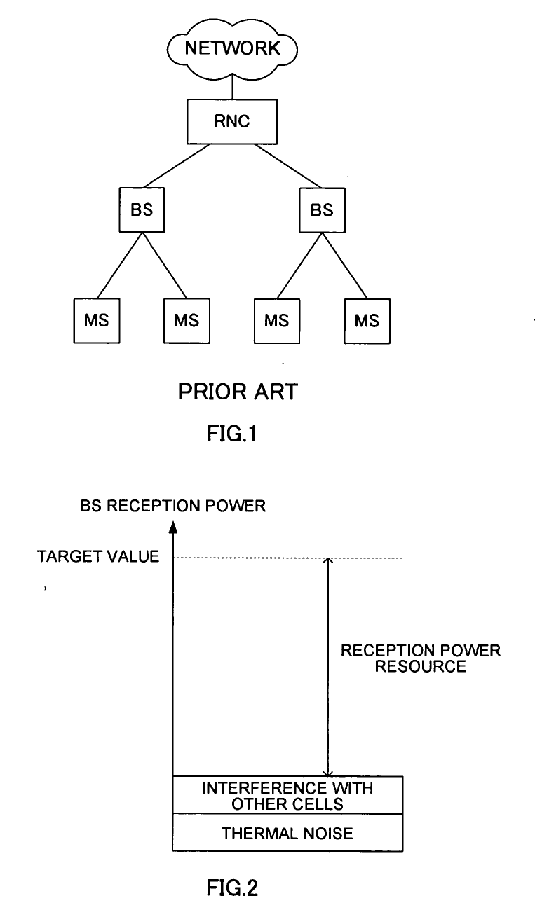

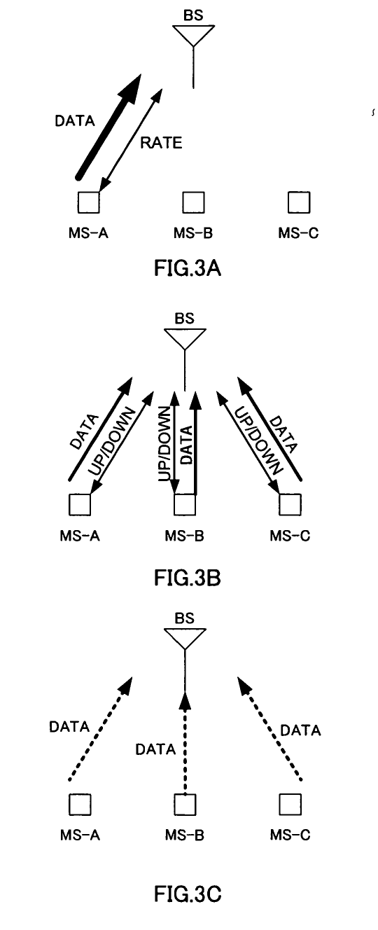

In the above embodiments, reception power resources set in a BS by a superordinate apparatus have been described as a value obtained by subtracting interference power of other cells and thermal noise power from a total reception power target value, as shown in FIG. 2, but the present invention is not limited to this case. Anything can be used for reception power resources set in a BS by a superordinate apparatus as long as it is a parameter related to reception power resources. Examples of parameters that can be used include total reception power, the ratio of total reception power to thermal noise power, the ratio of total reception power to interference power, the ratio of total reception power to interference power+thermal noise power, the total reception power of E-DCH related channels, the ratio of the total reception power of E-DCH related channels to thermal noise power, the ratio of the total reception power of E-DCH related channels to interference power, the ratio of the total reception power of E-DCH related channels to interference power+thermal noise power, the ratio of total reception power to the total reception power of E-DCH related channels, and the ratio of total reception power to the total reception power of DCH related channels. Whichever parameter is used, that parameter is converted to reception power resources within the BS.

In the above embodiments, distribution of reception power resources set by an RNC which is the superordinate apparatus of a BS—that is, distribution to a plurality of transmission schemes used in uplink data transmission—is performed not by the RNC but by the BS. Furthermore, switching among a plurality of transmission schemes is also performed by the BS. By this means, reception power resource distribution and switching among a plurality of transmission schemes can be controlled at high speed, the utilization efficiency of reception power resources can be improved, and user throughput and system throughput can be improved in a radio communication system. Moreover, the amount of signaling between the superordinate apparatus and a base station apparatus can be greatly reduced.

The present application is based on Japanese Patent Application No. 2004-37082 filed on Feb. 13, 2004, the entire content of which is expressly incorporated by reference herein.

### INDUSTRIAL APPLICABILITY

A scheduling apparatus and scheduling scheme of the present invention have an effect of improving user throughput and system throughput in a radio communication system, and are useful for uplink data transmission.

1. A scheduling apparatus comprising:
a distribution section that distributes a reception power resource set by a superordinate apparatus to a plurality of transmission schemes used in uplink data transmission; and
a scheduling section that executes uplink data transmission scheduling in accordance with reception power resources distributed to said plurality of transmission schemes.

2. The scheduling apparatus according to claim 1, wherein said distribution section comprises a setting section that sets one reception power resource that is distributed to one transmission scheme of said plurality of transmission schemes to a predetermined value, and sets another reception power resource that is distributed to another transmission scheme to a value obtained by subtracting said predetermined value from the reception power resource set by said superordinate apparatus.

3. The scheduling apparatus according to claim 2, wherein said setting section sets said one reception power resource that is distributed to said one transmission scheme to a maximum value that can be used by said one transmission scheme.

4. The scheduling apparatus according to claim 2, wherein said setting section sets said one reception power resources that is distributed to said one transmission scheme to a minimum value that can be used by said one transmission scheme.

5. The scheduling apparatus according to claim 2, wherein said setting section sets said one reception power resource that is distributed to said one transmission scheme within a range from a minimum value to a maximum value that can be used by said one transmission scheme.

6. The scheduling apparatus according to claim 1, wherein said distribution section comprises a setting section that sets a reception power resource that is distributed to at least one transmission scheme of said plurality of transmission schemes based on a past scheduling result of said scheduling section.

7. The scheduling apparatus according to claim 1, wherein:
said scheduling section comprises:
a dedicated scheduling section that executes scheduling corresponding to one transmission scheme of said plurality of transmission schemes; and
an acquisition section that acquires a surplus reception power resource remaining in executed scheduling;
and said distribution section comprises an adding section that adds the acquired surplus reception power resources to another reception power resource that is distributed to another transmission scheme of said plurality of transmission schemes.

8. The scheduling apparatus according to claim 1, wherein said distribution section performs reception power resource distribution based on information reported from a mobile station apparatus indicating an amount of data in said mobile station apparatus or variation of said amount of data.

9. The scheduling apparatus according to claim 1, further comprising a selection section that selects, based on reported information reported from a mobile station apparatus, at least one transmission scheme to be used by said mobile station apparatus form among said plurality of transmission schemes;
wherein said distribution section performs reception power resource distribution in accordance with a selection result of said selection section.

10. The scheduling apparatus according to claim 9, wherein said selection section switches a transmission scheme of said mobile station apparatus in a previous scheduling result of said scheduling section to another transmission scheme based on said reported information.

11. The scheduling apparatus according to claim 9, wherein said selection section decides for each of said plurality of transmission schemes whether or not that transmission scheme should be used by said mobile station apparatus based on said reported information.

12. A base station comprising the scheduling apparatus according to claim 1.

13. A radio communication system comprising the scheduling apparatus according to claim 1.

14. A base station apparatus comprising:
a decision section that decides, based on information reported from a mobile station apparatus, about a transmission scheme to be used by said mobile station apparatus;
a distribution section that distributes a reception power resource set by a superordinate apparatus to a plurality of transmission schemes used in uplink data transmission based on said reported information and a decision result of said decision section;
a scheduling section that executes uplink data transmission scheduling in accordance with reception power resources distributed to said plurality of transmission schemes; and
a signaling section that signals a decision result of said decision section to said mobile station apparatus.

15. A mobile station apparatus that performs uplink data transmission to a base station apparatus, said mobile station apparatus comprising:
a reporting section that reports information relating to said mobile station apparatus to said base station apparatus;
a detection section that detects signaling from said base station apparatus of a transmission scheme decision result based on reported information; and
a transmitting section that performs uplink data transmission using a detected transmission scheme.

16. A scheduling method comprising:
a distribution step of distributing a reception power resource set by a superordinate apparatus to a plurality of transmission schemes used in uplink data transmission; and
a scheduling step of executing uplink data transmission scheduling in accordance with reception power resources distributed to said plurality of transmission schemes.
